(19) United States
(12) Patent Application Publication
(10) Pub. No.: US 2010/0077292 A1
(43) Pub. Date: Mar. 25, 2010

(54) Automated feature-based to do list

(76) Inventor: Scott C. Harris, Rancho Santa Fe, CA (US)

Correspondence Address: SCOTT C HARRIS;Law Office of Scott C Harris, Inc, P O BOX 1389, Rancho Santa Fe, CA, 92067-1389, US

(21) Appl. No.: 12/238,330

(22) Filed: Sep. 25, 2008

(51) Int. Cl. G06F 17/00; G06F 3/048

(52) U.S. Cl. 715/232; 715/230; 715/768

(57) ABSTRACT

A picture is used as a to do list. The picture is obtained either as a still image, or as a frame of the video. Once obtained, the picture can be annotated in various ways to indicate information about the image that made it interesting to the user. Various information about the image is also stored.

### BACKGROUND

People use different ways of organizing the things that they want to do in the future. Many people use lists, e.g., “to do lists” or whiteboards to keep track of these organizational processes. The problem with paper, of course, is that you have to find the paper, you can cross things out, but there's no easy way to reorder the list. Also, the way in which you do these things depends on the availability of having paper. If you don't have your to-do list when you want to do something, you have to remember to put it on the to do list later.

### SUMMARY

The present application takes advantage of the fact that “a picture is worth 1000 words” in an embodiment. An embodiment describes a system that automatically obtains information using a hand-held portable device, and forms to-do lists based on the information. The information can be in different kinds of forms, including pictures and others.

According to an aspect, a system according to the present application might capture a picture using a camera or capture a frame from a TV or video screen. The system allows annotating the captured picture or frame with notes and other information in order to determine the kind of information to be stored. This becomes a master to do list, which can be arranged in one of a plurality of different orders.

### BRIEF DESCRIPTION OF THE DRAWINGS

In the drawings:

FIG. 1 shows an operative diagram of a first embodiment which uses a PDA to obtain a picture of an item;

FIG. 2 shows a user interface interacting with the picture; and

FIG. 3 shows an embodiment which uses a hand-held device to determine a picture using a network communication.

### DETAILED DESCRIPTION

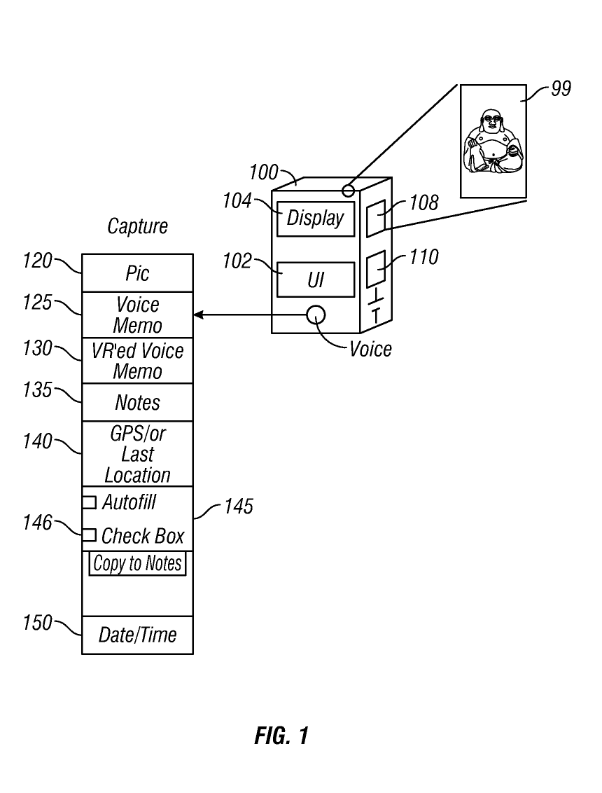

A first embodiment is shown in FIG. 1. In this embodiment, a hand-held portable device 100 which can be a communicator, e.g., a cell phone, PDA, or any device which operates using battery power, is capable of obtaining a picture. The device also includes, for example, a user interface which may be a keyboard or number keys 102, and a display screen 104. In the case of the conventional telephone, the display might display pictures backgrounds or the like. The portable device also includes a processor shown as 108, and stored memory 110. The memory can be a nonvolatile memory such as a flash drive, or can be a higher capacity storage memory.

The system can be used to take photos and make calls as conventional. However, a to-do list can also be formed by making a specified file format. According to a first embodiment, the to-do list is formed by a combination of a number of different possible pieces of information that can be arranged in a way that assist the user in forming the list. The information may include a picture 120, such as a picture taken by PDA 100 of the item 99. The picture 120 may be associated with a first set of information that is automatically obtained from the picture, and a second set of annotations which has been added by the user. A first annotation is a voice memo 125. In an embodiment, therefore, the user could take a picture, and record a voice memo that is associated with the picture where the voice memo says “I saw this at store X, and I want one of them”. The voice memo can automatically be voice recognized, to create a voice recognized voice memo portion which can be formed as text associated with the picture. The user can also enter notes as conventional as 135.

When storing an item for later callup, the location where the item is located may be an important piece of information. In an embodiment, an automatically-determined location, e.g., a location obtained by GPS or any other form of finding the location may be stored. This may be the location where the picture was taken in this embodiment. If no current location is possible, then the last accurate location may be stored as 140. For example, if the user is in a house, the user may not be receiving GPS or cell reception, but the last valid location might still be a useful bit of information. The GPS location may be stored in any form such as longitude or latitude, but when expanded, may show map and/or cross street information or address information.

145 corresponds to online content obtained based on the other information. This can be machine recognized information, e.g., a machine recognized version of the photo. It can be information associated with the voice memo. It can also be based on the notes. Another auto recognized part can be directions, for example, to the auto-detected location. For example, one of the auto filled fields can be directions from a current location to the location. A date and time are also stored at 150. For each of the auto filled items, there can be checkboxes such as 146, that allow a user to opt out of any or all of the auto-found information.

In an embodiment, after obtaining information about the item 99, the system finds the auto fill information 145 either immediately, or based on off-line content, or the like. For example, during idle times, some of the information may be used in a database to find the off-line content. For example, the information in the notes can be compared with keywords, to determine categories of the notes—e.g., are the notes about shoes, about groceries, etc.

The location where the picture was taken or where the note was created can be looked up. For example, this can determine if the picture was taken at a store, on a road, etc. The picture itself can be compared with pictures in a database.

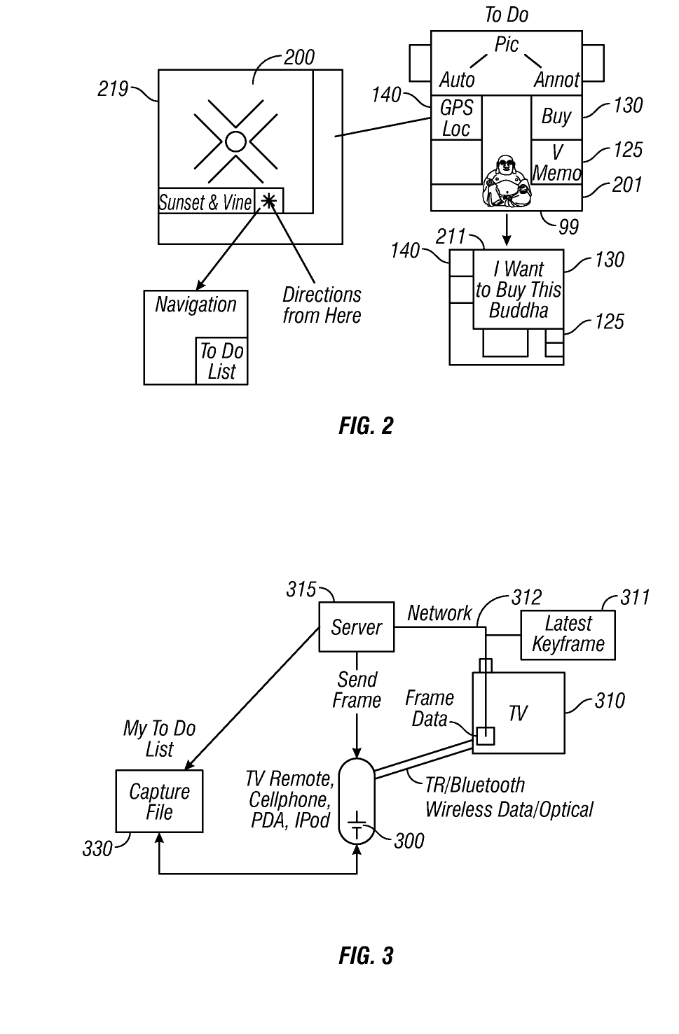

When the user pulls up the to-do list, the user gets an image of the form shown in FIG. 2. The picture itself 99 forms the main part of the image, and the other portions may be formed as frames associated with areas in the image. For example, the voice recognized voice memo 130 may be shown as one portion of the to do memo, associated with the image and saying for example, “I want to buy this”.

The memo is shown, for example, as a separate layer that overlays the image, and is partly transparent so that the image can be seen through the memo layer. The user can use their cursor or other selector e.g. touchscreen to touch any portion and select that portion. For example, if the user touches the portion 130, the transparency level of that portion changes to make that level less transparent and hence making it more readable. When the portion is touched, it becomes less transparent. When not touched, the layer is partially transparent, so that the image can be seen through the transparent portion of the layer.

According to another embodiment, touching the portion may also cause the portion to expand in size to it to achieve full screen or part screen. FIG. 2 shows the touching making the portion 211 become bigger covering substantially three quarters of the screen, and also no longer being transparent. More generally, the selected portion can be less transparent, with the amount of transparency being variable, up to full opacity. Some of the other frames can still be seen off to the side of the picture screen, and the picture itself 99 can also be seen. However this frame 130 has become the focus of the information. The other frames that would otherwise be covered by the expanded frame may be made smaller and moved in location.

Other information, such as the voice memo may also be shown. For example, the voice memo 125 may be shown as an icon indicating that it can be played. As it as an alternative to a voice memo, for example, there can be music or some background sound that is played.

There can be many uses for the picture or video of the to-do list. For example, one can take a picture of an area to which one might want to return. One could record a sound to go with the picture, for example. For example, you could record a voice memo. If you record an announcement over a PA that may be associated with your to do list, you might simply record that announcement. In a similar way, the automatically-detected location 140 can be selected. When selected, this may bring up the screen which shows information about the area, for example a map 220, a text box showing the address, as well as a “directions from here” icon. Selecting the “directions from here may also change the device into its navigation mode so that it automatically navigates to the location set in the notes.

According to this embodiment, therefore, a GPS location can be set as part of the contact, and by setting the directions from here icon, can automatically cause navigation to that area. Note also that the screen 219 in FIG. 2 is preferably in the same location on the screen where the icon was located. In any of these screens, for example in screen 211, the user can touch a different area of the screen to go back to either the screen 201, or to let a different icon obtain control of the screen. In the navigation mode, there is still another icon that allows going back to the to do list screen.

FIG. 3 illustrates an alternative embodiment which may be usable with the embodiment of FIG. 1. This embodiment also uses a portable handheld device 300. In this embodiment, the handheld device can be a TV remote, cell phone, PDA, or iPod, for example. The handheld device can store the to do list, and can also store other information. In addition, the handheld device may communicate with a remote server, which can be the item storing the to do list, or the to do list can be stored in another computer such as the user's personal PDA or the like.

The basic idea of this embodiment, however, is that the handheld device 300 communicates with a network communicating device 310 which in this embodiment is shown as a television set, but can be other devices other than a television set. In one embodiment, the Internet device 310 receives only two things from the handheld device: any indication of “now” and an indication of “me”. That is, in this embodiment, the only things that the television sends over the network are 1) what the television is showing right now and 2) an indication of the “source”, e.g., the person who asked for them. Because this only requires two pieces of information, it can be a reasonably universal system. The remote 300 can be a TV remote, but could also be any kind of device which is capable of sending any signal to the television. This could be an infrared signal, a Bluetooth signal, wireless data, or line of sight optical or sound. Any encoding that the TV is capable of handling will be sufficient. Once the TV receives the two pieces of information it needs: “now” and “me”, it creates a message that is sent over the network. In the example of a TV, sending that causes the TV to take its latest screenshot, e.g. its latest keyframe that it has stored. This keyframe is sent as 311 over the network 312 to a server 315. That server receives the frame data indicative indicative of the specific frame that has been sent, as well as the destination who it is going to be sent to. This destination could be a telephone number e.g. a cell phone number or an e-mail address or some other unique way of identifying the person. The information from the server can be sent wirelessly back to the remote device 300. Alternatively, it can be sent to a user's personal computer or storage area 330.

The user in these embodiments may store their lists, e.g., to do lists, “I am interested in” list, or others, online. This information can then become part of the user's personal profile. For example, by taking pictures, these pictures and information about the pictures can be stored online and used to automatically update the user's start page or home page with things they've seen during the day and information about those things.

Other automatic actions can be taken. Textual information in the picture can be optically character recognized, to find information about the contents of what is shown in the picture. If the person in the picture is a recognizable character, e.g., a famous actor, then that person's name can be added to the to-do list. If the picture is from a TV show or movie, the name of that TV show or movie can be added to the to-do list. The to do list can be annotated as in the first embodiment, and other annotations may be things that are more specific to video programming can be used, such as download this program later, record this program the next time it comes on, buy a DVD including this music, or others.

All of the annotation boxes 125-150 from the embodiment of FIG. 1 can be used with the frame capture system of FIG. 3, to add annotations of the picture to the capture file. This can include sounds, voice, text, location, or others.

The to-do list can use pictures as reminders for things. For example, one can obtain a frame of the video content, in which the frame the user likes something. Say you see an actress or model and you like their shoes. You can capture the frame and say or type “shoes”. This could be used to automatically tell an internet or other robot to try to find similar looking shoes.

It could be used so that the user can just remember that they want to look for shoes like this. In essence, this provides a reminder that you want more information about some part of the image, here the shoes, with the ability to tell the system what part of the image you want more information about.

In a similar way, the system allows capturing a frame from a movie or TV show, and entering certain designations associated with that TV show, such as the designation “other episodes”.

In one embodiment, instead of freeform text, information can be enter information from a pulldown menu. The pulldown menu facilitates automated processing of the information. For example, the pulldown menu may include all possible information about information in the picture, e.g clothes, actors, episodes. Here, you may select the term “clothes” from a menu. This provides submenus, including “I like these clothes I want to buy these clothes, or the like. Each of the submenus may be automatically processed, by a remote server, which can determine something about it.

The general structure and techniques, and more specific embodiments which can be used to effect different ways of carrying out the more general goals are described herein.

Although only a few embodiments have been disclosed in detail above, other embodiments are possible and the inventor intends these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, kinds of computers besides those specifically described can be used.

Also, the inventor intends that only those claims which use the words “means for” are intended to be interpreted under 35 USC 112, sixth paragraph. Moreover, no limitations from the specification are intended to be read into any claims, unless those limitations are expressly included in the claims.

The computers described herein may be any kind of computer, either general purpose, or some specific purpose computer such as a workstation. The computer may be a special purpose computer such as a PDA, cellphone, or laptop.

The programs may be written in C or Python, or Java, Brew or any other programming language. The programs may be resident on a storage medium, e.g., magnetic or optical, e.g. the computer hard drive, a removable disk or media such as a memory stick or SD media, wired or wireless network based or Bluetooth based Network Attached Storage (NAS), or other removable medium or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

What is claimed is:

1. A device comprising:
a storage part that stores an image;
an annotating part, that allows annotating the image to include information that is associated with the image; and an image retrieval part which allows retrieving the image along with said information associated with the image at a time subsequent to a time of storing the image and annotating the image.

2. A device as in claim 1, wherein said device is a communicator which includes a communication capability.

3. A device as in claim 2, wherein said device further includes a camera that allows obtaining said image.

4. A device as in claim 1, wherein said device obtains said image over a network.

5. The device as in claim 1, wherein said image is a frame of a video, and said information about the image is information related to some aspect of the video.

6. A device as in claim 3, further comprising an automatic position detecting device, and said annotating part automatically determines information about a location of the position detecting part and annotates the image with said location.

7. The device as in claim 1 wherein said device provides a display screen which includes both said image, and a number of options for adding information about said image.

8. A device, comprising:
a computer running a user interface, said user interface allowing storing and displaying an image, and storing and displaying a plurality of different items of information associated with said image, wherein said plurality of different information includes at least multiple different items of information, and said computer displays said image as a background image, and displays said plurality of items of information as partly transparent objects over said background image,
wherein selecting said partly transparent objects causes said object that is selected to become less transparent.

9. The device as in claim 8, wherein said objects, when selected, become substantially completely opaque so that said background image can be seen through said objects before selected, and said background image cannot be seen through said objects after said objects are selected.

10. The device as in claim 8, wherein said objects, when selected, increase in size, and show a first amount of information when unselected, and show more than said first amount of information on said increased size after being selected.

11. A device as in claim 8, wherein each of a plurality of objects includes different information about the image.

12. A device as in claim 11, wherein one of said objects includes information indicating a reason that a user obtained the image.

13. The device as in claim 11, wherein one of said objects includes information about a location where the image was obtained, said information being automatically obtained and associated with said image.

14. The device as in claim 12, wherein said object provides information that causes navigating to said location.

15. A method, comprising:
obtaining an image over a network connection;
automatically annotating said image, using a plurality of different annotations;
storing said image; and
later retrieving said image along with said annotations and displaying said image along with said annotations.

16. A method as in claim 15, wherein said storing said image comprises storing said image on a remote server.

17. A method as in claim 15, wherein said annotations are selected from a plurality of pulldown menus that define a number of different alternatives for annotating said image.

18. A method as in claim 15, wherein said image is a still image.

19. A method as in claim 15, wherein said image is a frame of a video.

20. A method as in claim 15, wherein said displaying comprises displaying said image and a plurality of different items of information as said annotations associated with said image, wherein said plurality of different information includes at least multiple different items of information,
said displaying comprising displaying said image as a background image, and displaying said plurality of items of information as partly transparent objects over said background image,
wherein selecting said partly transparent objects causes said object that is selected to become less transparent.

21. The device as in claim 20, wherein said objects, when selected, become substantially completely opaque so that said background image can be seen through said objects before selected, and said background image cannot be seen through said objects after said objects are selected.

22. The device as in claim 20, wherein said objects, when selected, increase in size, and show a first amount of information when unselected, and show more than said first amount of information on said increased size after being selected.

23. A method, comprising
responsive to an action taken during a playing of a video, receiving information indicative of a frame of the video;
annotating said frame of the video; and
at a time after said receiving, displaying said frame and said annotation.

24. A method as in claim 23, wherein said annotation comprises clothes within the video.

25. A method as in claim 23, wherein said annotation comprises other video programs like the video.
